(19) United States
(12) Patent Application Publication
(10) Pub. No.: US 2016/0042411 A1
(43) Pub. Date: Feb. 11, 2016

(54) SYSTEM AND METHOD FOR GENERATING A DESIGNATED APPLICATION PROGRAMMING INTERFACE FOR AUTOMATIC EXECUTION OF ACTIONS IN WEBPAGES

(71) Applicant: Taykey Ltd., Herzliya (IL)

(72) Inventors: Amit Avner, Herzliya (IL); Ofir Farchy, Modiyin (IL); Ido Ofzer, Tel Aviv (IL)

(73) Assignee: TAYKEY LTD., Herzliya (IL)

(21) Appl. No.: 14/818,370

(22) Filed: Aug. 5, 2015

Related U.S. Application Data
(63) Continuation of application No. 62/033,358, filed on Aug. 5, 2014.

(51) Int. Cl. G06Q 30/02; H04L 29/08; G06F 17/30; G06Q 30/06

(52) U.S. Cl. CPC G06Q 30/0277; G06Q 30/0631; G06Q 30/0643; H04L 67/02; G06F 17/3089

(57) ABSTRACT

A method and apparatus for automatic execution of actions over a web page are provided. The method include receiving a request from a client node to execute at least one action in a webpage; analyzing the webpage to identify at least one interactive platform accessible by the webpage; extracting at least one step from the webpage required in order to execute the at least one action within the at least one interactive platform; generating, based on the at least one extracted step, a designated application programming interface (DAPI) for executing the at least one action within the at least one interactive platform; and providing to the client node a standard application programming interface (API) that enables interaction with the DAPI.

### CROSS-REFERENCE TO RELATED APPLICATIONS

This application claims the benefit of U.S. Provisional Application 62/033,358 filed on Aug. 5, 2014, which is herein incorporated by reference for all that it contains.

### TECHNICAL FIELD

The disclosure generally relates to a system and method for automatic execution of actions in webpages, and more specifically to a system and methods for automatic execution of actions in webpages that do not have a built in application programming interface (API).

### BACKGROUND

The ubiquity of web platforms available on the Internet and the worldwide web (WWW) makes it complicated for new users to make simple actions like making a purchase through electronic commerce websites or publishing an advertisement in a webpage. These actions require certain sets of manual actions that users need to perform.

For example, some webpages such as Google® or Yahoo!®, provide a unique application programming interface (API) which a user wishing to publish an advertisement, or bid for a placement respective thereof, is expected to use. As another example, webpages such as Ebay® or Amazon® similarly provide a unique API which a user wishing to purchase an item is expected to use.

However, there are several platforms that do not have an API that allows users to automate a series of actions. For example, YouTube® enables publishing of advertising content in several ways but does not have any designated API for doing so.

It would therefore be advantageous to provide designated an API by which users can automatically execute actions in webpages that do not have a designated API.

### SUMMARY

A summary of several exemplary embodiments of the disclosure follows. This summary is provided for the convenience of the reader to provide a basic understanding of such embodiments and does not wholly define the breadth of the disclosure. This summary is not an extensive overview of all contemplated embodiments, and is intended to neither identify key or critical elements of all embodiments nor delineate the scope of any or all embodiments. Its sole purpose is to present some concepts of one or more embodiments in a simplified form as a prelude to the more detailed description that is presented later. For convenience, the term some embodiments may be used herein to refer to a single embodiment or multiple embodiments of the disclosure.

Certain embodiments include a method for automatic execution of actions over a web page. The method comprises: receiving a request from a client node to execute at least one action in a webpage; analyzing the webpage to identify at least one interactive platform accessible by the webpage; extracting at least one step from the webpage required in order to execute the at least one action within the at least one interactive platform; generating, based on the at least one extracted step, a designated application programming interface (DAPI) for executing the at least one action within the at least one interactive platform; and providing to the client node a standard application programming interface (API) that enables interaction with the DAPI.

Certain embodiments include an apparatus for automatic execution of actions over a network. The apparatus comprises: a processing unit coupled to the network; and, a memory coupled to the processing unit that contains therein instructions that when executed by the processing unit configures the apparatus to: receive a request from a client node to execute at least one action in a webpage; analyze the webpage to identify at least one interactive platform accessible by the webpage; extract at least one step from the webpage required in order to execute the at least one action within the at least one interactive platform; generate, based on the at least one extracted step, a designated application programming interface (DAPI) for executing the at least one action within the at least one interactive platform; and provide to the client node a standard application programming interface (API) that enables interaction with the DAPI.

### BRIEF DESCRIPTION OF THE DRAWINGS

The subject matter that is regarded as the disclosed embodiments is particularly pointed out and distinctly claimed in the claims at the conclusion of the specification. The foregoing and other objects, features, and advantages of the disclosed embodiments will be apparent from the following detailed description taken in conjunction with the accompanying drawings.

FIG. 1 is a schematic diagram of a networked system utilized to describe the various disclosed embodiments.

FIG. 2 is a communication block diagram showing the operation of the system after providing a DAPI in accordance with one embodiment.

FIG. 3 is a flowchart describing the operation of automatic executions of actions in webpages with one embodiment.

### DETAILED DESCRIPTION

The embodiments disclosed herein are only examples of the many possible advantageous uses and implementations of the innovative teachings presented herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views.

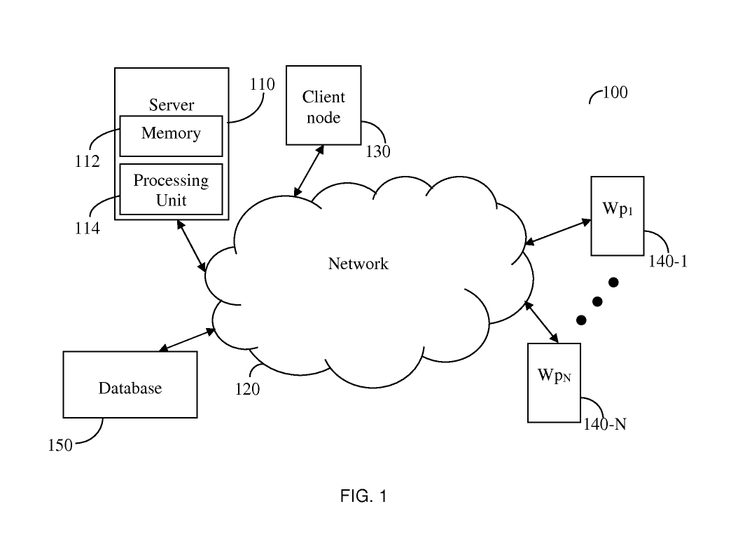

FIG. 1 depicts an exemplary and non-limiting schematic diagram of a networked system 100 in accordance with an embodiment. A server 110 is communicatively connected to a network 120. The network 120 can be wired or wireless, a local area network (LAN), a wide area network (WAN), a metro area network (MAN), the Internet, the worldwide web (WWW), the likes, any combinations thereof, and other networks capable of enabling communication between the elements of the system 100.

According to an embodiment, the server 110 is configured to receive a request from a client node 130 to execute an action in a webpage of a plurality of webpages 140-1 through 140-N, where N is an integer equal or greater than 1. The action may be, for example, publishing an advertisement, purchasing a good or service (hereinafter a “product”) in an electronic commerce (e-commerce) webpage, and the like. The advertisement may include any type of text, image, video, sound, a combination thereof, etc. The request may further include metadata associated with the action. The metadata may be, for example, budget constraints, associated time pointers, geographical pointers, etc. The client node 130 may be, for example, a smart phone, a mobile phone, a laptop, a tablet computer, a personal computer (PC), a personal digital assistant (PDA), a wearable computing device, and the like.

The server 110 is further configured to analyze the content of the webpage 140. The analysis may include scanning of all the visual and/or interactive elements shown in the webpage 140 and/or identification of all the elements with which the client node 130 can interact through the webpage 140. The analysis may include, for example, parsing the webpage and searching for HTML tags identifying visual and/or interactive elements.

Based on the analysis, the server 110 is configured to identify at least one interactive platform in association with the webpage 140. For example, in the case of purchasing a product, the platform may be an e-commerce platform. The e-commerce platform may be explicit. For example, in Amazon® there is an integrated application programming interface (API) by which the client node 130 can purchase a product based on, for example, search queries. Alternatively, the e-commerce platform in association with the webpage 140 may by implicit, where there are elements that enable purchasing products but there is no designated API that enables automatic purchasing of the products, for example a webpage maintained by a local brick and mortar store.

As another example, in the case of publishing an advertisement, the platform may be an advertisement platform. The advertisement platform may be explicit. For example, in Google® there is an integrated API by which the client node 130 can publish an advertisement based on, for example, search queries. Alternatively, the advertisement platform in association with the webpage 140 may by implicit, where there are elements that enable publishing advertisements but there is no designated API that enables automatic publishing of the advertisements, for example YouTube®.

Based on identification of the at least one interactive platform, the server 110 is configured to extract or identify, from the webpage 140, the steps required from the client node 130 in order to execute the action through the at least one interactive platform. For example, the steps may include a set of clicks or gestures received from the client node 130 over different portions of the webpage 140.

Using the extracted or identified steps, the server 110 is configured to generate a designated application programming interface (DAPI) for executing the steps within the at least one interactive platform. In an embodiment, the DAPI will include a translation from an API accessible by the client node 130 to the one or more identified steps. In an embodiment, the server 110 is configured to then provide to the client node 130 a standard API that enables the client node 130 to interact with the DAPI. The system 100 may further include a database 150 configured to store data related to the operation of the client node 130 with respect to the DAPI for further use.

In certain configurations, the server 110 comprises a processing unit 112 which is coupled to an internal memory 114. The processing unit 112 may include one or more processors. The one or more processors may be implemented with any combination of general-purpose microprocessors, multi-core processors, microcontrollers, digital signal processors (DSPs), field programmable gate array (FPGAs), programmable logic devices (PLDs), controllers, state machines, gated logic, discrete hardware components, dedicated hardware finite state machines, or any other suitable entities that can perform calculations or other manipulations of information.

In an embodiment, the memory 114 contains instructions that when executed by the processing unit 112 results in the performance of the methods and processes described herein below. Specifically, the processing unit 112 may include machine-readable media for storing software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the one or more processors, cause the processing unit 112 to perform the various functions described herein.

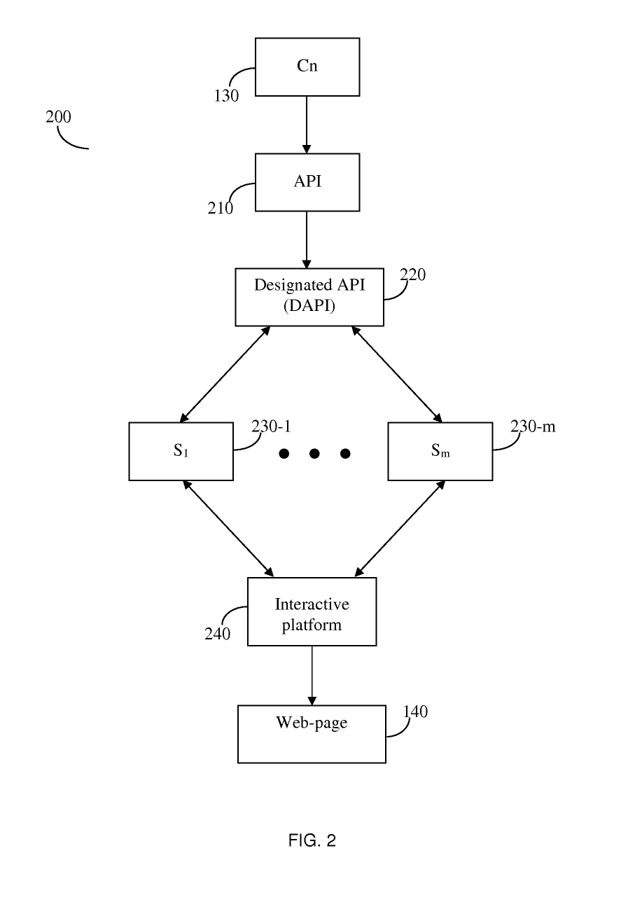

FIG. 2 is an exemplary and non-limiting communication block diagram 200 showing the interaction with the webpage 140 through a DAPI in accordance with one embodiment. According to this embodiment, a request to execute an action is sent from the client node 130 through the API 210. As noted above, the API 210 is provided by the server 110 in order to enable the communication of the client node 130 with the DAPI 220.

In an embodiment, the request may further include metadata associated with the action. The metadata may be, for example, budget constraints, associated time pointers, geographical pointers, and so on. The DAPI 220 is configured to perform the steps 230-1 through 230-m required in order to execute the action by the at least one interactive platform 240 in the webpage 140.

Returning to the example of publishing an advertisement as described with respect to FIG. 1, following the execution of the request to publish the advertisement, the advertisement is then displayed in the webpage 140. Returning to the example of purchasing a product as described with respect to FIG. 1, following the execution of the request to purchase the product, the steps 230-1 through 230-2 may include, presenting a shopping cart to the client 210, displaying a “check out” button, displaying a billing form, displaying a shipping form, and so on.

According to another embodiment, the server 110 is further configured to provide one or more recommendations to the client node 130 respective of the type of action and/or the associated metadata. The recommendations may be, but are not limited to, a recommended advertising plan, recommended products to purchase, and the like.

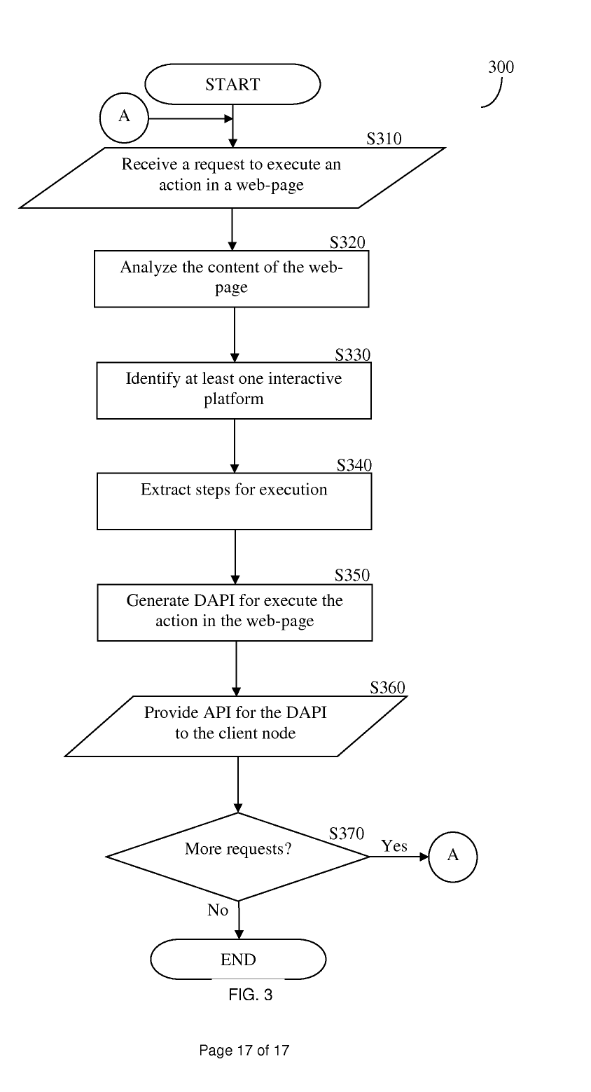

FIG. 3 depicts an exemplary and non-limiting flowchart 300 describing the automatic executions of actions in webpages in accordance with one embodiment. The method may be performed by the server 110. Without limiting the scope of the disclosed embodiment, the method will be discussed with reference to the various elements shown in FIG. 1.

In S310, a request to execute an action in a webpage 140 is received. The action may be, but is not limited to, publishing an advertisement, purchasing a product in an e-commerce webpage, and the like.

In S320, the content of the webpage 140 is analyzed. The analysis may include scanning of all the visual and/or interactive elements shown in the webpage 140 and/or identification of all the elements with which the client node 130 can interact through the webpage 140. The analysis may include, for example, parsing the webpage and searching for HTML tags identifying visual and/or interactive elements.

In S330, at least one interactive platform in association with the webpage 140 is identified by the server 110. The at least one interactive platform may include, but is not limited to, an advertisement platform, e-commerce platform, and the like. In S340, one or more steps required in order to execute the at least one action within the at least one interactive platform are extracted. In an embodiment, the steps may include a set of clicks or gestures received from the client node 130 over different portions of the webpage 140.

In S350, a designated application programming interface (DAPI) is generated for executing the at least one action within the at least one interactive platform. The DAPI is generated to provide a client node 130 a standard API to perform certain actions on the interactive platform accessible by the webpage 140.

In S360, an application programming interface (API) that enables the client node 130 to interact with the DAPI is provided by the server 110 to the client node 130. In S370, it is checked whether there are more requests and if so, execution continues with S310; otherwise, execution terminates.

The various embodiments of the disclosure are implemented as hardware, firmware, software, or any combination thereof. Moreover, the software is preferably implemented as an application program tangibly embodied on a program storage unit or computer readable medium consisting of parts, or of certain devices and/or a combination of devices. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such computer or processor is explicitly shown. In addition, various other peripheral units may be connected to the computer platform such as an additional data storage unit and a printing unit. Furthermore, a non-transitory computer readable medium is any computer readable medium except for a transitory propagating signal.

All examples and conditional language recited herein are intended for pedagogical purposes to aid the reader in understanding the principles of the disclosed embodiments and the concepts contributed by the inventor to furthering the art, and are to be construed as being without limitation to such specifically recited examples and conditions. Moreover, all statements herein reciting principles, aspects, and embodiments of the disclosure, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

1. A method for automatic execution of actions over a web page, comprising:
receiving a request from a client node to execute at least one action in a webpage;
analyzing the webpage to identify at least one interactive platform accessible by the webpage;
extracting at least one step from the webpage required in order to execute the at least one action within the at least one interactive platform;
generating, based on the at least one extracted step, a designated application programming interface (DAPI) for executing the at least one action within the at least one interactive platform; and
providing to the client node a standard application programming interface (API) that enables interaction with the DAPI.

2. The method of claim 1, wherein the interactive platform is an advertisement platform.

3. The method of claim 2, wherein the action is to publish at least one advertisement.

4. The method of claim 1, wherein the interactive platform is an e-commerce platform.

5. The method of claim 4, wherein the action is to purchase at least one product through the e-commerce platform, wherein a product is any one of: a good or a service.

6. The method of claim 1, wherein the request further comprises metadata associated with the at least one action.

7. The method of claim 6, further comprising:
providing, based on the associated metadata, a recommendation respective of the action.

8. The method of claim 6, wherein the associated metadata is at least one of: budget constraints, associated time pointers, and preferred demography.

9. The method of claim 1, wherein the analysis further comprises:
scanning the received webpage; and
identifying at least one of: visual elements and interactive elements by which the client node can execute actions through the webpage.

10. The method of claim 9, wherein the DAPI is generated to provide to the client node a standard API to execute the at least one action on the interactive platform accessible by the webpage.

11. A non-transitory computer readable medium having stored thereon instructions for causing one or more processing units to execute the computerized method according to claim 1.

12. An apparatus for automatic execution of actions over a network comprising:
a processing unit coupled to the network; and,
a memory coupled to the processing unit that contains therein instructions that when executed by the processing unit configures the apparatus to:
receive a request from a client node to execute at least one action in a webpage;
analyze the webpage to identify at least one interactive platform accessible by the webpage;
extract at least one step from the webpage required in order to execute the at least one action within the at least one interactive platform;
generate, based on the at least one extracted step, a designated application programming interface (DAPI) for executing the at least one action within the at least one interactive platform; and
provide to the client node a standard application programming interface (API) that enables interaction with the DAPI.

13. The system of claim 12, wherein the interactive platform is an advertisement platform.

14. The system of claim 13, wherein the action is to publish at least one advertisement.

15. The system of claim 12, wherein the interactive platform is an e-commerce platform.

16. The system of claim 15, wherein the action is to purchase at least one product through the e-commerce platform, wherein a product is any one of: a good or a service.

17. The system of claim 12, wherein the request further comprises metadata associated with the at least one action.

18. The system of claim 17, further configured to:
provide, based on the associated metadata, a recommendation respective of the action.

19. The system of claim 17, wherein the associated metadata is at least one of: budget constraints, associated time pointers, and preferred demography.

20. The system of claim 12, further configured to:
scan the received webpage; and
identify at least one of: visual elements and interactive elements by which the client node can execute actions through the webpage.

21. The system of claim 20, wherein the DAPI is generated to provide to the client node a standard API to execute the at least one action on the interactive platform accessible by the webpage.
